(19) United States
(12) Patent Application Publication
(10) Pub. No.: US 2025/0364779 A1
(43) Pub. Date: Nov. 27, 2025

(54) LASER BASED ON A DIELECTRIC RESONATOR WITH GAS OR PLASMA AT POPULATION INVERSION

(71) Applicant: Ramot at Tel-Aviv University Ltd., Tel-Aviv (IL)

(72) Inventors: Tal CARMON, Tel-Aviv (IL); Raanan GAD, Tel-Aviv (IL); Sile NIC CHORMAIC, Tel-Aviv (IL)

(73) Assignee: Ramot at Tel-Aviv University Ltd., Tel-Aviv (IL)

(21) Appl. No.: 19/291,733

(22) Filed: Aug. 6, 2025

Related U.S. Application Data
(63) Continuation of application No. PCT/IL2024/050140, filed on Feb. 6, 2024.
(60) Provisional application No. 63/443,486, filed on Feb. 6, 2023.

(51) Int. Cl. H01S 3/23; H01S 3/0943

(52) U.S. Cl. CPC H01S 3/2308; H01S 3/0943

(57) ABSTRACT

An optical cavity resonator, comprising a transparent or nearly transparent dielectric, and having gas or plasma provided thereabout, the resonator constructed to have an optical resonance that extends to partially spatially overlap with said gas or plasma, the gas or plasma providing an optical gain at a frequency overlapping a resonant frequency of said resonator, wherein the optical cavity, with plasma, is constructed to be pumped so that the plasma is able to amplify light at a frequency approximately related to an atomic transition of said gas or plasma.

### RELATED APPLICATIONS

This application is a Continuation of PCT Patent Application No. PCT/IL2024/050140 having International filing date of Feb. 6, 2024, which claims the benefit of priority under 35 USC § 119(e) of U.S. Provisional Patent Application No. 63/443,486 filed on Feb. 6, 2023. The contents of the above applications are all incorporated by reference as if fully set forth herein in their entirety.

### FIELD AND BACKGROUND OF THE INVENTION

The present invention, in some embodiments thereof, relates to a laser based on a dielectric resonator. More particularly, but not exclusively, the present invention relates to photonic devices capable of generating stimulated emissions, by using plasma or gas, and especially those that do not use mirrors, as common in the current state of the art.

Nowadays, laser emitters and amplifiers are used in commercial applications, including barcode scanners, laser radars or Lidar, inertial navigation systems, frequency combs, atomic clocks, local oscillators, synthesizers, and medical applications. The lower the optical loss in the laser resonator, the better their performance. While semiconductor lasers are very common, cheap and mass-produced, semiconductor sources are challenging to incorporate into optical high-Q microresonators due to optical loss that reduces performance. Current high-quality microresonators therefore typically require a cumbersome and expensive emitter.

Optical cavities are used in gyroscopes, frequency combs, and local oscillators, including local oscillators for atomic clocks and radar systems. These cavities are typically simple, reliable, small, and cheap; yet, the light sources needed to emit light into these cavities are typically large, cumbersome, and expensive. The current state of the art for introducing light to such optical cavities includes an external-cavity semiconductor-laser (e.g., Velocity™ TLB-6700 Widely Tunable Laser, www(dot)newport(dot)com/f/velocity-wide-&-fine-tunable-lasers) or a distributed-fiber-Bragg [DFB] laser where stability is achieved by injecting the microcavity scattering back to a semiconductor laser. Current solutions for introducing light into high Q microcavities are at the $10,000 price-range. This high price relates to the need for narrow linewidth sources which are at the exact resonance frequency of the optical cavity. The main technology stopper is that the simpler semiconductor lasers are challenging to integrate with ultrahigh quality-factor cavities since their inherent optical absorption reduces the cavity quality factor.

Various micro-cavity resonators have been utilized to re-circulate light and store optical power. In a typical whispering gallery micro-cavity resonator, light mostly travels around an interior surface of the cavity while partially extending out of it. The optical power stored in the resonator can be used in cavity quantum electrodynamics (cQED), photonics, and various optics applications. For example, U.S. Pat. No. 6,633,696 describes the use of a micro-cavity resonator as an optical signal modulator.

The surface roughness or finish usually affects the Q factor of the resonator, which is a measurement of the relationship between stored energy and the rate of dissipation of the energy. Resonators having both high Q factors and ultra-high Q factors are known in the art. For purposes of establishing a point of reference, a “high” Q factor is generally defined as a Q factor between about 10⁴ and about 10⁶, and an “ultra-high” Q factor is generally defined as a Q factor greater than 10⁶.

Surface-tension induced micro-cavities (STIM), such as droplets, glassmicro-spheres or toroids, are examples of known high Q and ultra-high Q micro-cavities. Some STIMs, are known to have Q factors that approach 10⁹. However, such ultra-high Q STIMs are typically confined to the laboratory as a result of the fabrication controls required to produce and maintain the spherical shape. For example, to introduce light into such high Q or ultrahigh Q microcavities, one has to ensure that the resonance condition is satisfied. Microresonators are at resonance when their effective circumference equals an integer number of optical wavelengths. An additional requirement is that the resonant wavelength should be exact to within 1/Q of its value.

For this reason, the current state of the art relies on narrow linewidth lasers such as external cavity semiconductor lasers, gas lasers, solid-state lasers such as Titanium Sapphire, or lasers that are frequency doubled. These lasers are typically larger than 10 centimeters and are expensive. An alternative way to introduce light to microcavities is to use a gain medium such as a semiconductor laser-gain diode, couple it to the resonator using a coupler such as a prism coupler, and amplify backscattering originating from the resonator. This method is generally referred to as injection locking. Lasing can occur in the resonator by processes such as Raman lasing, Brillouin lasing, or lasing by rare-earth dopants such as Erbium ions; yet, such processes require a second wavelength of light to resonate in the cavity, so that again-an external large and expensive laser is required. An injection locking system may provide a viable alternative.

In summary, the contemporary art provides cheap, reliable, and small semiconductor lasers that lase upon the insertion of electrical current. However, the current art does not have a way to introduce light to high Q and ultra high Q microcavities except for using injection locking or an external cavity source or an external-cavity laser.

### SUMMARY OF THE INVENTION

The present embodiments may provide a laser based on a dielectric resonator with gas or plasma at population inversion.

The present embodiments may provide an optical cavity resonator, comprising a transparent or nearly transparent dielectric, and having gas or plasma, at population-inversion state, provided thereabout. The resonator is constructed to have an optical resonance that extends to partially overlap with the gas or plasma. Gas or plasma provides an optical gain by stimulated emission when its population is inverted. Additionally, the dielectric cavity resonates at an optical frequency that is spectrally overlapping, or nearly overlapping, with the atomic (or molecular) plasma transition frequency that provides the optical gain. The optical gain, originating from population inversion in the plasma (or gas) material together with the optical feedback, provided by the optical resonator, give rise to laser emission. Laser emission from the dielectric resonator occurs when the optical gain provided by the plasma is larger than the optical loss.

The present embodiments may reduce the cost of optical sources for microcavities for example to less than $1, by unifying the light source and optical resonator without increasing its size and price and with no need for external components. As with semiconductor lasers, plasma based lasers may conveniently be electrically pumped. Yet, in contrast with semiconductor lasers, plasma and gasses may be transparent enough not to significantly degrade the cavity quality factor.

It is noted that gas or plasma has not been used in optical microresonators or microcavities or large dielectric resonators that contain no mirrors, as we suggest here.

Uniquely, gas or plasma provides optical gain with minimal damage to cavity quality factor. What was not previously experimentally demonstrated or reported, not even theoretically, is that plasma or gas at population inversion, may partially overlap with dielectric microcavities, such as whispering gallery mode resonators, to provide optical gain, light amplification, and laser emission. These functions are important in supporting cheap and reliable micro emitters with narrow linewidth typical to cavities with high-quality factor.

According to an aspect of some embodiments of the present invention there is provided an optical cavity resonator, comprising a transparent or nearly transparent dielectric, and having gas or plasma provided thereabout, the resonator constructed to have an optical resonance that extends to partially spatially overlap with the gas or plasma, the gas or plasma providing an optical gain at a frequency overlapping a resonant frequency of the resonator, wherein the optical cavity is constructed to contain the gas or plasma and to be pumped with energy such that the gas or plasma is able to amplify light at a frequency approximately related to an atomic transition of the gas or plasma.

The dielectric may be glass or silicon and may be provided as a hollow shell or as a disc.

In an embodiment, said gas or may be any of Nitrogen, CO2, Argon ions, Helium-Neon mixture, ammonia, and a Xenon-Neon Mixture.

An embodiment may bring the gas or plasma to an optical population inversion state, where it can provide optical gain and laser emission; using any of electric discharge, molecular collisions, flow, heat, chemical reaction, and optical pumping with another source of light.

The optical cavity resonator may be a micro-cavity resonator.

Optical resonances may partially overlap with regions outside or inside the resonator, to which regions the gas or plasma is introduced.

Optical resonances may partially overlap with regions outside and inside the resonator, to which regions the gas or plasma is introduced, such that the gas or said plasma is both inside and surrounding the optical cavity resonator, the resonator thereby propagating an optical mode partially at a solid part of the microcavity and partially at those regions to which said gas or plasma has been introduced.

Embodiments may bring more than half of the gas or plasma atoms to an excitation energy level, and such a state is generally referred to as “population inversion”.

Embodiments may amplify spontaneous emission occurring at a population inversion region, and/or amplify a weak seed light source, and/or amplify light originating from noise, and/or amplify light from thermal background radiation.

In embodiments amplifying is carried out by the gas or plasma, and feedback inherent to resonators may populate one or more of the cavity modes at a predetermined power.

In embodiments, the predetermined power is between 1 nano Watt and 1 Watt.

Photons from the above amplification may circulate while partially in contact with the population-inversion region, and may remain in phase for numerous circuits, for distances that may even reach kilometers, without requiring any special alignment of components.

Laser light from the micro-cavity may be coupled to the outside of the resonator. Coupling may be designed so that for example after fifty round trips of light, half of the photons have exited.

Coupling laser light out of the resonator may involve scattering the light from a rough surface, using a brag grating, using radiation at a sharp curve, using a nearby tapered fiber, using a nearby waveguide, using a bent waveguide, and using a prism.

The transparent or nearly transparent dielectric may comprise a hollow shell or a disc, and may be incorporated into an optical gyroscope, an optical gyroscope used for internal navigation, a ring laser gyroscope (RLG), a ring cavity gyroscope, a local oscillator, a local oscillator operating in the 7 to 30 GHz band and based on beating two resonator optical modes, with related frequency separation, on a photodiode, a narrow-linewidth laser emitter, and a micro frequency comb.

According to a second aspect of the present invention there is provided a method of providing laser light, comprising providing a gas or plasma at an optical population inversion around a transparent or nearly transparent dielectric, the dielectric providing a resonant cavity therewithin, the cavity having an optical resonance that extends to partially spatially overlap with the gas or plasma, the gas or plasma thereby providing an optical gain at a frequency overlapping a resonant frequency of the resonant cavity, and,
pumping the gas or plasma with energy, thereby causing the plasma to amplify light at a frequency approximately related to a relevant atomic transition of the gas or plasma.

According to a third aspect of the present invention there is provided a method of providing laser light, comprising:
fabricating a microbubble cavity from a fused silica glass microcapillary;
   providing a gas or plasma at an optical population inversion around a transparent or nearly transparent dielectric within the cavity, the cavity having an optical resonance that extends to partially spatially overlap with the gas or plasma, the gas or plasma thereby providing an optical gain at a frequency overlapping a resonant frequency of the resonant cavity, and
pumping plasma, thereby causing the plasma to amplify light at a frequency approximately related to a relevant atomic transition frequency of the gas or plasma.

The cavity may be fabricated with initial inner and outer diameters of 200 μm-300 μm or 250 μm and 300 μm-400 μm or 350 μm respectively.

The fabrication may involve introducing pressurised gas into said microcapillary, turning on a laser to slowly increase temperature until the walls of the capillary become hot and soft enough to allow the pressurised gas to expand the capilliary and form a bubble.

Fabrication may involve continuing to expand the bubble until reaching a diameter in the range of 80-200 μm.

The gas being introduced may for example be N₂ gas at around 3 Bar.

The method may involve initially tuning and then slowly detuning the laser, when the gas is at population inversion.

The method may require that a significant part of a mode-volume of the optical resonance overlaps with an inner volume of the micro bubble cavity.

The gas pressure within the cavity may be at least 2.5 Torr, for example three Torr or 5 Torr.

The method allows for repeated plasma ignition.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWING(S)

The patent or application file contains at least one drawing executed in color. Copies of this patent or patent application publication with color drawing(s) will be provided by the Office upon request and payment of the necessary fee.

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 schematically illustrates a photonic device according to embodiments of the present invention, which is capable of generating stimulated emission using gas or plasma at population inversion;

FIGS. 2A-2C are three plots illustrating the radial refractive index distributions for a spherical dielectric shell, the optical potential this dielectric creates, the optical potential well at the shell region, and the intensity of the optical mode that populates the potential well, according to embodiments of the present invention;

FIG. 3 is a plot illustrating the optical mode intensity distribution along the radial direction, according to embodiments of the present invention;

FIG. 4 schematically illustrates an energy level diagram of gas or plasma at population inversion, according to embodiments of the present invention;

FIG. 5 schematically illustrates the principle of operation for a photonic device that is capable of generating stimulated emission, according to embodiments of the present invention;

FIG. 6 illustrates a cross-sectional view of a further device according to an embodiment of the present invention using a photonic crystal fiber or a photonic crystal resonator.

FIGS. 7A-7C illustrate a dielectric sphere made of amorphous silica, that is surrounded by plasma, according to embodiments of the present invention;

FIGS. 8A and 8B illustrate a dielectric shell made of amorphous silica, with plasma at its inner part on the left and a micrograph of the amorphous silica shell with glowing plasma inside on the right;

FIG. 9 illustrates a dielectric disk made of amorphous silica (right), and a plasma cell to which the disk is inserted (left);

FIG. 10 illustrates an optical microcavity with gas inside under pressure;

FIGS. 11A-11G together make up a schematic description of the plasma-containing microcavity and its calculated transmission response for changes in the plasma's absorption and refractive index;

FIGS. 12A-12D schematically illustrate a prototype arrangement according to the present embodiments;

FIGS. 13A-13E illustrate experimental results obtained with the prototype arrangement of FIGS. 12A-12D;

FIG. 14 illustrates experimental results using a 5 Torr pressure in the cavity according to the present embodiments;

FIG. 15 illustrates an arrangement according to the present embodiment for manufacturing a cavity according to the present embodiments; and

FIG. 16 illustrates a plasma emission spectrum as measured via free space, as used in the present embodiments.

### DESCRIPTION OF SPECIFIC EMBODIMENTS OF THE INVENTION

The present invention, in some embodiments thereof, relates to a laser based on a dielectric resonator.

The present embodiments may provide an optical cavity resonator which comprises a transparent or nearly transparent dielectric and has gas or plasma at population inversion provided thereabout. The resonator is constructed to have an optical resonance that extends to partially overlap with gas or plasma, while gas or plasma provides optical gain by stimulated emission. Additionally, the optical cavity resonates at a frequency that is spectrally overlapping with the frequency of the relevant molecular or atomic transition to provide optical gain. The dielectric resonator provides optical feedback, while plasma provides an optical gain. Laser emission will appear when the optical gain, by the plasma, is larger than optical loss.

The present embodiments may replace semiconductors, in high-Q microresonator and laser devices, with gas that is much more transparent when compared with materials used to electrically pump high-Q resonators. Accordingly, it may be possible to manufacture cheap, small, and accurate Lidars, frequency combs, atomic clocks, and gyroscopes in cars and cellular phone applications. The major technology barrier for such applications is the lack of a cheap, small, and simple narrow-linewidth emitter that our invention addresses.

Accordingly, a photonic device is disclosed herein, which has gas or plasma at population inversion, resulting in laser emission or light amplification. An optical cavity resonator, made of a sufficiently transparent dielectric, is adapted so that its optical resonance evanescently extends to partially overlap with gas or plasma, the whole having optical gain, to result in light amplification by stimulated emission of radiation, that is to say a laser. In this manner, the optical cavity is pumped to become a laser or to amplify light at a wavelength approximately related to the relevant atomic transition wavelength of the gas. Gasses or plasma used to provide the optical gain include, but are not limited to, Nitrogen, CO2, Argon ions, Helium-Neon mixture, ammonia, or Xenon-Neon Mixture. Bringing the gas or plasma to optical population inversion may utilize, but is not limited to, any of electric discharge, molecular collisions, flow, heat, chemical reaction, and optical pumping with another source of light.

Emission or amplification may be at any spectral band of the electromagnetic spectrum, including X-ray, Ultraviolet, Visible, Infrared, and Microwave. The plasma or gas that provides gain can be focused toward near the optical mode, may be inside a hollow dielectric-resonator, or outside of a dielectric resonator.

Embodiments are directed toward a photonic device having stimulated emission and a method of generating stimulated emissions from a photonic device. Such stimulated emission, primarily originating from a region partially overlapping with the optical mode of the resonator, is emitted by gas, a mixture of gases, or plasma.

In embodiments, the micro-cavity resonator is adapted to exhibit optical resonances that partially overlap with regions outside or inside the resonator where gas or plasma are introduced. As a result, the optical mode partially propagates at the solid part of the microcavity and partially at the gas regions.

In embodiments, the gas or plasma is adapted to operate at optical population inversion.

In embodiments, more than half of the gas or plasma atoms are at an energy level higher than the level below. Additional requirements are needed, as known in the art, to turn such a system, generally referred to as a 3 level system, or a 4 level system, at population inversion, to amplify light by stimulated emission.

In embodiments, spontaneous emission occurs at the population inversion region, and/or at a weak seed light source, and/or using light originating from noise, and/or using light from thermal background radiation. Some of this emission will be amplified by the gas or plasma and with the feedback inherent to resonators will populate one or more of the cavity modes at a required power that is typically between 1 nano Watt and 1 Watt, but is not limited to these powers. As such, these photons circumferentially circulate, or achieve another shape or a round trip of any other shape, while partially in contact with the population-inversion region gain region. Stimulated emission then occurs, and the apparatus then turns into a device providing light amplification by stimulated emission of radiation, or laser.

In embodiments, the method includes optically coupling the laser light that resonates in the micro-cavity to the outside of the resonator. The micro-cavity resonator is adapted to exhibit a region where light may exit the cavity. Coupling laser light out of the resonator may be achieved via light scattering from a rough surface or a nano-particle, a brag grating, radiation at a sharp enough curve, a nearby tapered fiber, a nearby waveguide, a bent waveguide, a prism, or any other method. It is also possible not to couple the laser light out of the resonator.

Ionized gas, i.e. plasma, is a medium where electrons-ions dynamics are electrically and magnetically altered. In optics, electric and magnetic fields can therefore modify plasma's loss, refraction, and gain. Hence, integrating plasma in micro-photonics may benefit picosecond switches and ultra-coherent micro-laser applications, and fundamental studies in electron accelerators, relativistic-, and nonlinear-optics. Still, plasma's low pressure and large electrical fields have presented as challenges to introducing it to micro-cavities. Thus, as explained above, the present embodiments use microbubble cavities with walls thinner than an optical wavelength to evanescently push their optical resonances to partially overlap with plasma. The present embodiments may electrically ignite Argon plasma inside high quality cavities and measure a refractive index reduction below one. Also, the present embodiments may introduce absorption-induced transmission, inverse to coherent-perfect-absorbers, by using plasma absorption to switch on the light in a cavity-coupled telecom-compatible fibre. Photographs of the plasma's micro-striations, with 35 μm wavelength, indicate magnetic fields interacting with plasma. The synergy between micro-photonics and plasma may transform micro-cavities and electro-optical interconnects by adding additional knobs for electro-optically controlling light using currents, electric-, and magnetic-fields. Considering longer-term benefits, introducing active media such as plasma at population inversion to microcavities may permit a new type of electrically-pumped ultra-coherent microlaser, which may be suitable for many applications.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

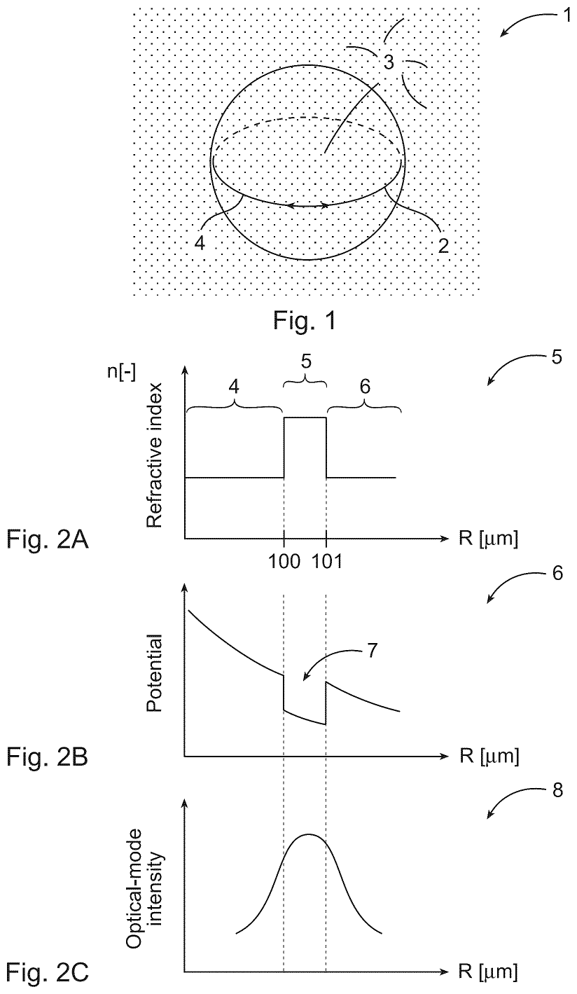

Referring now to the drawings, FIG. 1 schematically illustrates a photonic device, 2, which may comprise a shell. The shell may be made of transparent dielectric material, as will be discussed in greater detail below. The device is capable of generating stimulated emission as indicated by arrow 4; using gas or plasma indicated by dots. The gas or plasma is at a state of population inversion, and is located both around the shell in region 1 and within the shell in region 3. The photonic device may thus be a shell dividing between interior and exterior regions of gas to which population inversion is applied. Alternative embodiments may be considered

FIGS. 2A-2C are three plots illustrating three different properties and how they differ with respect to the radius of the shell. In FIG. 2A, the radial refractive index distributions are shown against radius for a spherical dielectric shell where 5 indicates the shell region. FIG. 2B illustrates the optical potential that the dielectric creates 6, and numeral 7 illustrates the optical potential well at the shell region. FIG. 2C shows the intensity 8 of the optical mode that populates the potential well. In a particular case, this may also be a non-shell refractive index distribution with a related potential and mode shape.

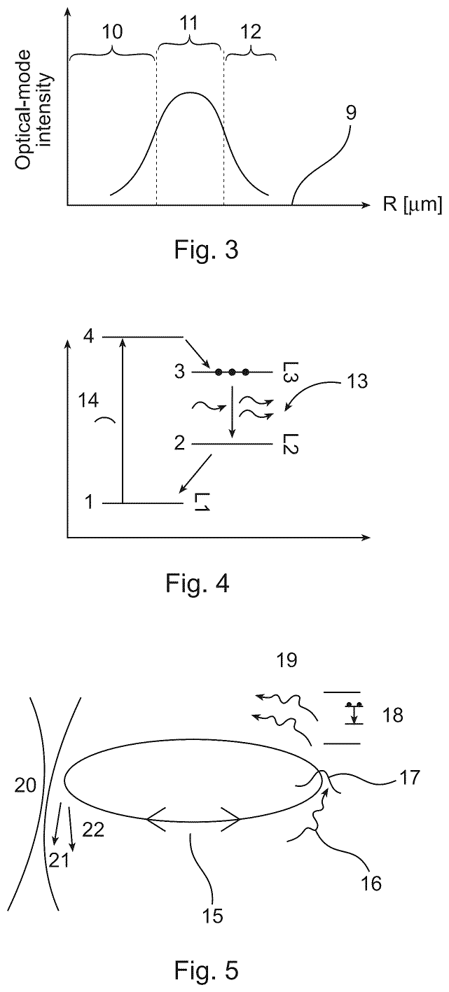

FIG. 3 is a plot illustrating the optical mode intensity distribution along the radial direction 9 of the shell. Region 11 represents the dielectric shell, typically made of glass. Region 10 represents the inner part of the shell, and region 11 represents the outer part of the shell.

Reference is now made to FIG. 4, which schematically illustrates an energy level diagram of gas or plasma at population inversion. This energy level diagram is generally referred as representing a “4-level system”. That is to say, energy levels which we may term as L1, L2, L3 and L4, are present Typically, transitions between energy levels L1 to L4, L4 to L3, and L2 to L1 are fast compared to the spontaneous transition time between levels L3 to L2, resulting in more than half of the molecules or atoms having an energy equal to that of the third level. Typically, the non-radiative transitions from L3 to L2 are rare as their lifetime is very long. This situation is called “population inversion”. A photon approaching the system, with wavelength near that of the L3 to L1 transition results in stimulated emission 13, turning into two photons to result in optical gain whilst the atom energy drops down to level L2. This process then perpetually repeats upon the existence of a pump, 14, that takes atoms from energy level L1 to energy level LA. Pumping atoms from level L1 to L4 may be done using electrical discharge, chemical process, heat, atomic collisions, or light.

FIG. 5. schematically illustrates the principle of operation for a photonic device that is capable of generating stimulated emission. Light propagates along a circular track 15 that makes a ring shape. The track may be partially contained in the dielectric resonator and partially at the inner and outer part 17 of the dielectric shell containing gas or plasma at population inversion 18. Light in the form of a photon 16 interacts with the inverted population atom 18 to generate two photons 19 via stimulated emission. This gain gives rise to lasing that populates the resonator mode. Laser radiation may then be coupled out of the resonator via optical couplers such as tapered fiber 20, via Rayleigh scattering, or via a process relevant to a circular resonator and called “radiation” or “radiation losses”.

Possible commercial uses include:

Optical gyroscopes such as those that may be used for internal navigation. The present embodiments may significantly simplify optical gyroscopes such as a ring laser gyroscope (RLG) or a ring cavity gyroscope. Local oscillators operating at the 7 to 30 GHz band may beat two resonator optical modes, with related frequency separation, on a photodiode. Such electrical oscillators are used in atomic clocks and radar systems.

Small narrow-linewidth laser emitters. Such lasers are used for Holographic 3D Mapping Systems.

Micro frequency combs are used as an accurate measuring tool, and the present embodiments may allow them to be made cheaper and smaller.

The optical gyroscope may be used as the gyroscope in inertial navigation systems [INS]; with volume, weight, and price that may be a 100 times smaller compared with the current state of the art in fiber-optic and ring-laser gyroscopes [FOG and RLG].

From a broader view which also includes GPS and vision-based navigation, the known non-inertial solutions rely on electromagnetic interaction with the outer world and are hence sensitive to natural obstacles and countermeasures—see Table 1 below. In contrast, a miniaturized gyro manufactured according to the present embodiments may allow navigation systems to be proof against interruption, both natural and person-made; while being mass-produced at a price compatible for critical missions such as driving, flying, and sailing, as well as for cellular-phone navigation inside buildings and shopping malls where GPS reception is challenging.

TABLE 1
Sensitivity of various navigation systems.

| | | | Lidar/Camera/Randar | | | | | |
|---|---|---|---|---|---|---|---|---|
| Inertial navigation system | | | sensitivity | | | GPS sensitivity | | |
| Disruption | | | Disruption | | | Disruption | | |
| Counter | Proof | [symbol] | Counter | Laser | [symbol] | Counter | Jammers | [symbol] |
| measures | | [symbol] | measures | blinders | | measures | Spoofing | [symbol] |
| | | | | Flares/chaff | [symbol] | | | |
| Natural | Proof | [symbol] | Natural | Sun | [symbol] | Natural | Tunnels | [symbol] |
| interruptions | | [symbol] | interruptions | Fog | [symbol] | interruptions | Skyscrapers | [symbol] |
| Cumulative | Suffers | [symbol] | Cumulative | No | [symbol] | Cumulative | No | [symbol] |
| error | from | | error | cumulative | | error | cumulative | |
| | cumulative | | | error | | | error | |
| | error | | | | | | | |

The current state of the art in optical micro-gyroscopes includes the recent experimental demonstration of optical micro-gyros at sizes permitting their integration in cell phones; yet, mass production of such devices is challenging due to the narrow linewidth of the resonator that currently requires manual fabrication and consequently a high price tag. In greater detail, it was shown experimentally that gyroscopes are scalable to volumes and weights 1000 times better than the current state of the art in FOG and RLGs. Brillouin amplification in micro photonics, is a feature that improves on-chip micro-gyros by extending the effective propagation distance of light, e.g., from 1 km to 10 km, and correspondingly increasing gyro sensitivity to rotation. This benefit of gain that effectively extends the propagation distance is sometimes provided in the frequency domain where it is known as “line narrowing” or “Schawlow-Townes narrowing” Again, mass production of micro-gyros was challenging because of expensive materials, non-parallel manual fabrication, and expensive components inherent to the current technology of introducing light (pumping) by narrow linewidth sources or injection locking systems.

Technological limitations that currently prevent micro-gyros from penetrating the transportation, and cellular markets include expensive materials. The challenges include the required diamond materials, non-parallel fabrication, alignment of optical components, and expensive components such as distributed Brag fiber lasers [DFB] or external cavity semiconductor lasers. These technological limitations relate to a fundamental physical limitation that prevents using a cheap and simple light source, such as the semiconductor laser in say a typical laser pointer. In detail, resonators supporting 400 meters of light propagation, as typical in micro-gyros, require a coherent light source that keeps the optical field oscillation in a perfectly sinusoidal manner for 400,000,000 optical cycles. Such lasers are expensive and large due to their external cavity components and manual alignment. Therefore, alternative methods include injecting of distributed-fiber-Bragg lasers scattering from the resonator, back to the DFB. This method is generally referred to as back injection. However, back injection requires several components (laser, resonator, lenses, coupler, and waveguide) that may have to be manually aligned, and a relatively expensive DFB.

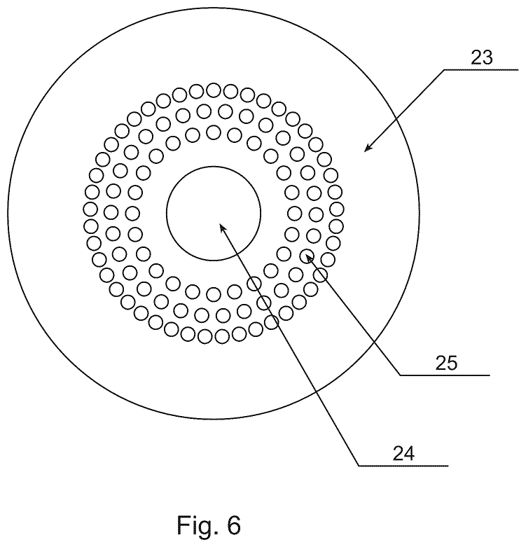

Reference is now made to FIG. 6, which illustrates a cross-sectional view of a photonic crystal fiber device where guidance of light in its two transverse directions is by interference or Bragg reflection and where plasma is introduced in its voids. More particularly, a dielectric sphere of amorphous silicon is surrounded by plasma, and confinement of light in directions transverse to light propagation is by the arrangements of dielectric regions 23 made of material such as glasses, in combination with a large void 24 and small voids 25 where one can introduce plasma to generate the laser. Confining light in the direction out of the plane of the page, and parallel to light propagation, may be done by other means, including mirror or distributed fiber Bragg. The device of FIG. 6 is generally referred to as a photonic crystal fiber or a hollow core bandgap fiber.

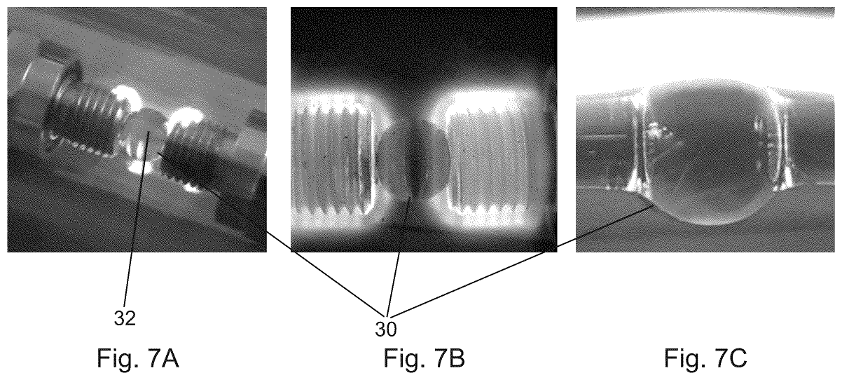

Reference is now made to FIGS. 7A, 7B and 7C, which are three views of a dielectric sphere 30 made of amorphous silica, that is surrounded by plasma 32, according to embodiments of the present invention.

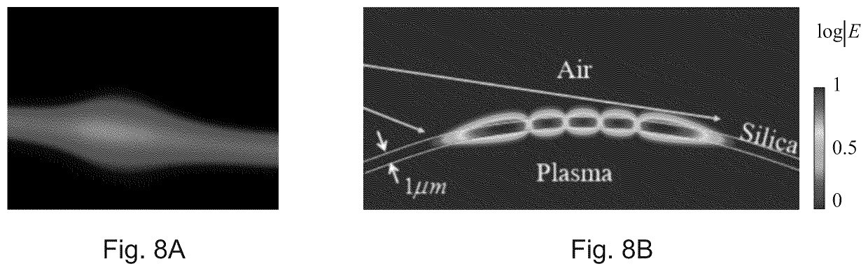

Reference is now made to FIGS. 8A and 8B, which illustrate a dielectric shell made of amorphous silica, with plasma at its inner part FIG. 8B and a micrograph of the amorphous silica shell with glowing plasma inside FIG. 8A. FIG. 8B shows the result of a numerical calculation of an optical whispering gallery mode that circulates along the shell equator. Colors stands for the amplitude of the electric field. As one can see, most of the light is propagating in the dielectric silica, and about 4% of the light is propagating at the inner region where plasma is ignited.

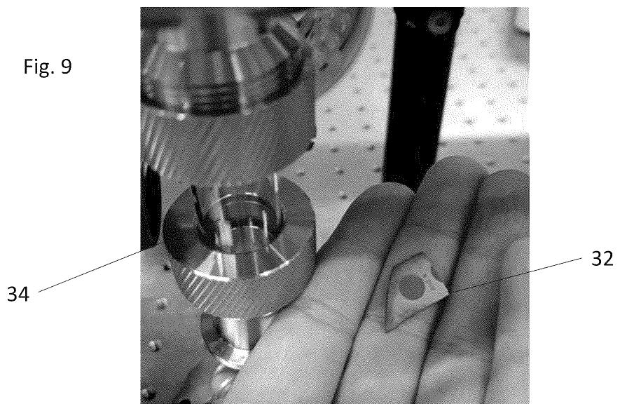

FIG. 9 illustrates a dielectric disk made of amorphous silica 32, and a plasma cell to which the disk is inserted 34, according to embodiments of the present invention.

The present embodiments may provide on-chip gyroscopes with the design explained herein, leading to price and volume reduction. The present embodiments may allow building of the resonator, the laser source, the output coupler, and all of the gyro components automatically together in a single-shot combined process. The present method is compatible with parallel fabrication techniques where thousands of gyros may be made in parallel.

The present embodiments involve the following points.

They may make use of a gas or plasma reservoir;

They may make use of a photonic crystal structure in 1D, 2D or 3D as the resonator or part of the resonator or to confine light near plasma;

They may make use of random laser;

They may provide room for extra gas or plasma;

They may make use of isotopes such as Helium 3, but are not limited to this isotope;

Embodiments may use isotope combinations such as Neon 20 and Neon 22, including for preventing competition between clockwise circulating and counter-clockwise laser modes, but not limited to this isotope's combination;

Embodiments may make use of ballast transformers;

Embodiments may use capacitors and inductors, in particular for improving “cosine phi” or for benefiting plasma ignition;

Embodiments may provide a plasma laser operating in pulses;

Embodiments may provide a plasma laser operating continuously in time (“continuous wave” or “CW”);

Embodiments may use permanent magnets to increase ionisation, and manipulate the plasma or gas density and temperature;

Embodiments may use electromagnets to increase ionisation, and manipulate the plasma or gas density and temperature;

Embodiments may make use of cooling by natural convection, or cooling by forced convection, or cooling by radiation;

Embodiments may involve rotating the resonator back and forth, including for preventing locking of the clockwise circulating and counter-clockwise laser modes;

Embodiments may involve rotating the resonator;

Embodiments may be used to generate more than one laser line;

Embodiments may use nonlinear optical effects in combination with the plasma laser line;

These nonlinear effects include second-harmonic generation [SHG], third-harmonic generation (THG), high harmonic generation (HHG), Sum-frequency generation (SFG), Difference-frequency generation (DFG), Optical Parametric processes, Half-harmonic generation, Optical rectification (OR), Nonlinear light-matter interaction with free electrons and plasmas, Optical Kerr effect, Optical solitons, and Wave Mixing (WM);

Embodiments may involve Q switching of the laser;

Embodiments may use nonlinear optical effects such as Chi 2, Chi 3, Raman, and Brillouin including for generating a frequency comb from the plasma laser;

Embodiments may use the plasma-laser emission for generating another laser. The other laser can be a Brillouin laser, a Cascaded Brillouin laser, a Raman laser, a Cascaded Raman laser, an Erbium ion laser, or a rare-earth dopant laser;

Embodiments may involve use of nonlinear optical effects such as Chi 2, Chi 3, Raman, and Brillouin to generate white light emission that is continuous or almost continuous in wavelength;

Embodiments may involve beatnoting two or more laser lines, and using a photodetector or a photodiode to turn the optical beatnote into electrical oscillation, including at high signal-to-noise ratio, and including at high rates;

Embodiments may use the plasma laser emission as the light source for; or as a part of an optical synthesizer, an atomic clock, a local oscillator, a frequency comb, or a white light source;

Embodiments may slow the speed of light in the plasma resonator, including for the purpose of improving the laser sensitivity for rotation;

Embodiments may control the relative power between the clockwise and counter-clockwise laser modes, including for the purpose of reducing the variation between the speed of light in the clockwise and counter-clockwise direction that is induced via the Kerr effect;

Embodiments may use an inductive coupled plasma (ICP) or capacitively coupled plasma (CCP) source;

Embodiments may use spectroscopy for plasma or gas measurement combined or separated from interferometric measurements of light plasma, or plasma parameters \ conditions etc.;

Embodiments may use glow and arc discharge plasma sources as per plasma creation and manipulation;

Embodiments may use electric and magnetic actuations controlling the plasma real-time both temporally and spatially;

Embodiments may use rf discharge for creation of and sustaining of the plasma.

As discussed above, once, micro-photonic devices relied mostly on solids. Here, by introducing plasma to microcavities, the present embodiments may provide an alternative to semiconductors in micro-photonics. This is because plasma may uniquely permit electrically controlling optical refraction, loss, and gain. Plasma as used in the present embodiments belongs to the noble-element family and therefore has minimal chemical reactivity of all materials and maximal durability.

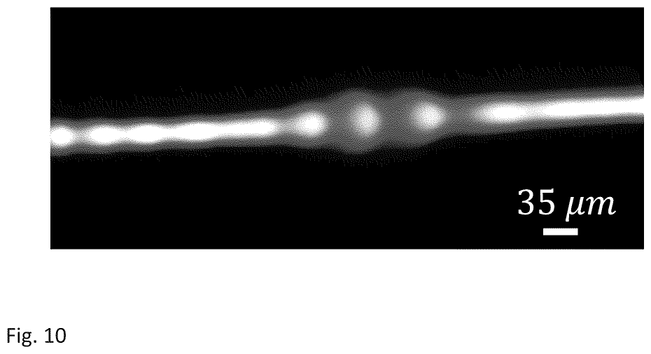

Referring now to FIG. 10, we experimentally demonstrate an optical micro-cavity with plasma inside, suggesting new types of electro optical micro-device.

Here we electrically change plasma absorption and refraction during a resonantly enhanced light-plasma interaction. The embodiments may thus provide use of plasma gain as an alternative to laser diodes, which can bring ultra-coherent emission to microphotonics. Such emitters are in demand for mass-producing small-size combs, LIDARs, gyroscopes, atomic clocks, optical synthesizers, and quantum devices that are of interest to a broad engineering readership. The synergy between a new phase of matter (plasma) and microphotonics may allow resonantly enhancing light-plasma interactions that can appeal to the broad scientific and technological community.

Optical microcavities with high quality factors have found numerous applications in ultralow-threshold lasers, combs, gyroscopes, detectors, atomic clocks, single-photon routers, LIDARs, optical synthesizers, cavity quantum electrodynamics, and biological microfluidic sensors. Electro-optically controlling refractive index and absorption in such cavities can enable a new type of microdevice. For example, electrically tuning several resonators to similar resonance frequencies might help commercialize exceptional-point sensors, and sharper top-hat filters. Furthermore, we demonstrate here that absorption results in a seemingly surprising mechanism of absorption-induced transmission that electrically turns on light via a standard fibre. Embodiments may do that by critically coupling a fibre to a cavity operating near resonance and therefore, even though the cavity material is highly transparent, light is not transmitted through the fibre. Such devices are generally referred to as coherent perfect absorbers. When we invert cavity material from transparent to opaque (here, by electrically igniting plasma), the coherent absorber is destroyed, and the fibre turns transparent.

More than just electrically changing refraction and absorption, plasma can also permit optical gain by electrical pumping. In this regard, further embodiments may relate to plasma at population inversion that provides optical gain. Large plasma-based lasers have been known since 1963, but were never miniaturize to the micron scale. For instance, Argon and Helium-Neon lasers are electrically pumped like semiconductor lasers. The gasses in these lasers (e.g., argon) belong to the family of noble elements whose outer shell of valence electrons is full. Therefore, these elements are the most resistant to chemical reactions, ageing, and thermal effects. Accordingly, plasma can provide optical gain that does not suffer ageing, temperature sensitivity, or a challenging flat beam profile, in contrast to semiconductors. Indeed, ultra-coherent plasma lasers have been reported to operate for decades, naturally raising the motivation to reduce their size from benchtop scale to a several micrometer size. Integrating electrically-pumped plasma gain into microresonators may hence turn laboratory microcavity experiments into real-world applications. A major technology barrier, in this regard, relates to the required mass production of high-coherence micro-emitters. Semiconductor lasers were used extensively for the purpose of high-coherence emitters, while the relatively low coherence of the laser diode was compensated for by using external cavities such as the ones relying on distributed-fiber-Bragg [DFB] gratings. Optical coupling was then established between the DFB laser and the microcavity. To improve coherence, the cavity's scattering was back injected into the DFB laser. It is hence natural to look at combining the optical gain provided by electrically-pumped plasma with ultrahigh coherence cavities to achieve a mass-producible ultra-coherent micro-laser in one piece. We demonstrate here the first step of electrically changing plasma absorption and refraction in microcavities, which proves the feasibility of bringing a similar plasma microphotonic device to population inversion and lasing.

Accordingly in the present embodiments we introduce plasma, known as the fourth state of matter, to microcavities. Then, using our plasma-containing microcavity, we show absorption-induced transparency of these high-Q fibre-coupled microphotonics. Additionally, we show that plasma electrically changes absorption and refraction of high-Q microphotonics.

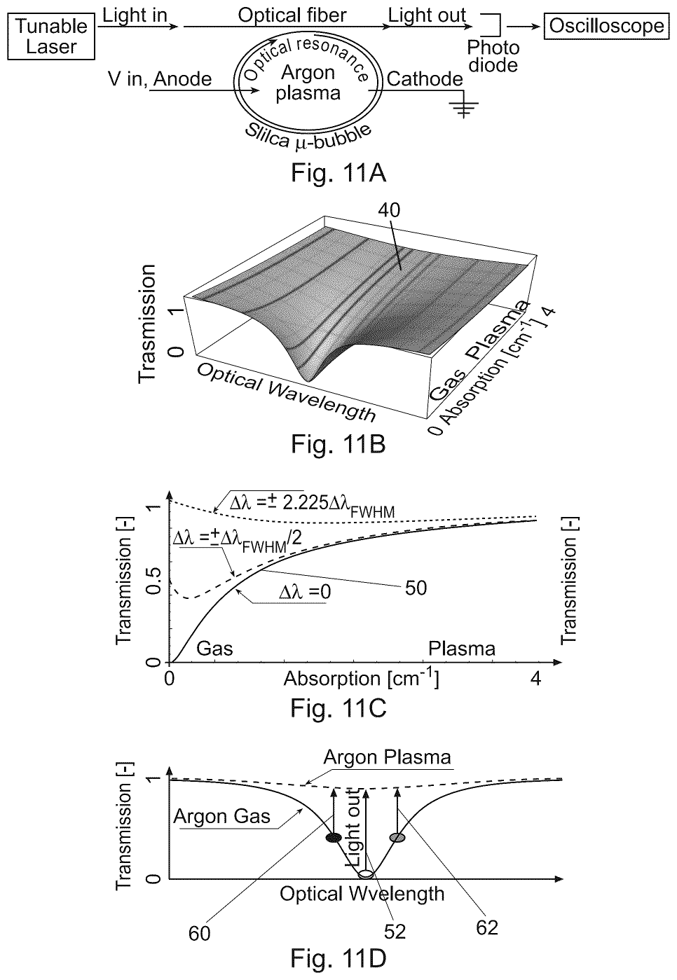

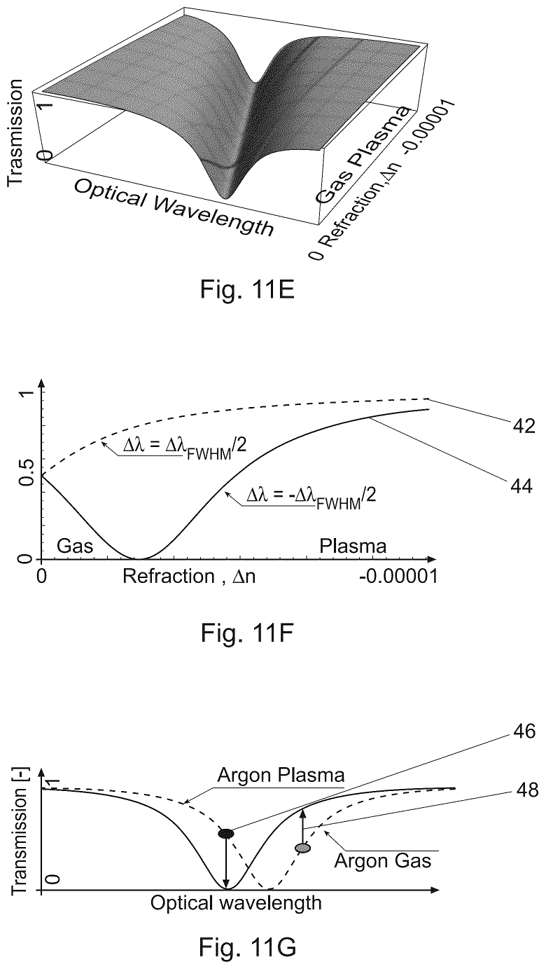

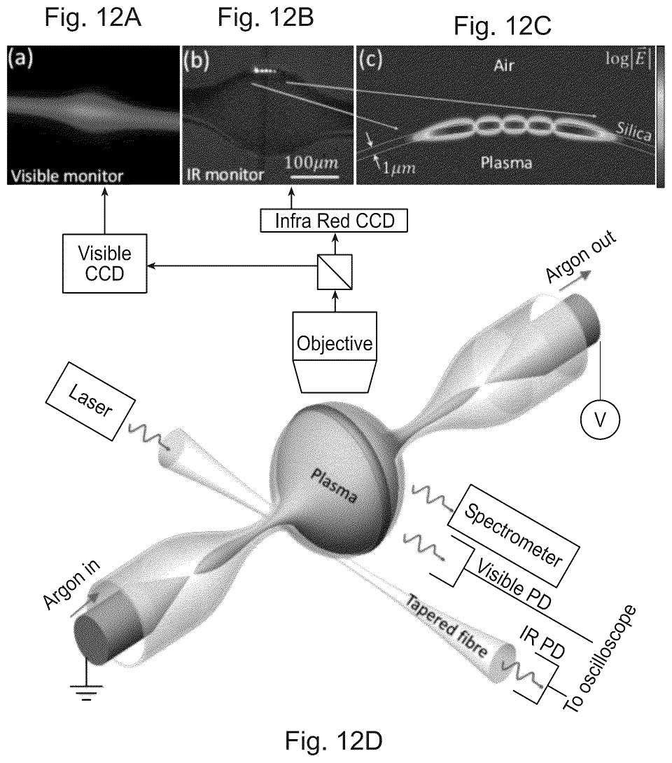

Reference is now made to FIGS. 11a-11g, which together make up a schematic description of the plasma-containing microcavity (a) and its calculated transmission response for changes in the plasma's absorption (b-d) and refractive index (e-g). We assume Lorentzian resonance absorption. Absorption-induced transmission is evident in b-d, as indicated by the green lines and arrow in b-c. Absorption-induced effects are symmetrical with detuning, as indicated by the blue and red lines and arrows in b and d. On the contrary, index-induced effects for blue or red detuning are different, as indicated by the blue and red lines and arrows. In more detail, the schematic description of the present electro-optical system includes plasma in the inner part of a micro-bubble resonator (FIG. 12a). The microbubble cavity resonantly enhances light when its circumference is an integer number of optical wavelengths. Crucially, a significant part of the resonance's mode-volume overlaps with the inner volume of the micro bubble, where plasma resides, allowing us to electrically change the resonance properties by electrically ionizing argon gas creating plasma or by plasma recombination processes.

In all the microresonators that have been used until now, the light propagates in solid. liquid, or gas media. Here, for the first time to our knowledge, we demonstrate a plasma-filled micro-resonator in which the optical resonance partially overlaps with plasm. The design and fabrication of the present microbubble resonator optimizes light extension into the plasma region. The resonator wall thickness is for example about 1 μm through pretapering a silica capillary, then heating using a CO₂ laser while controlling applied inner air pressure (see Methods 1 below). To further evanescently couple light into the inner plasma, we use a relatively long optical wavelength at 1.55 [symbol] m. For similar reasons, we use a relatively large resonator radius of 90 [symbol] m, thus reducing the tendency of light to centrifugally move away from the inner plasma. We then fill the micro-bubble cavity with argon gas and insert micro copper electrodes through both sides of the capillary. Sharp tipped electrodes are used to enhance the local electric-field to achieve gas-breakdown.

In more detail, assuming Lorentzian absorption that characterizes resonators, the calculated optical transmission through the fibre is³³

| | |
|---|---|
| 1) | $T = 1 - \frac{4 ( {δ}_{c} ) ( {δ}_{0} + )}{{( {δ}_{c} + {δ}_{0} + )}^{2} + {( Δω + )}^{2}} ,$ |

where δ₀ and δ_{c} represent the cavity coupling and loss rates, and Δω is the angular-frequency detuning between the laser and the cold cavity resonance. Plasma results in an additional cavity loss rate, [symbol] , and detuning, [symbol] , where the ˜ stands for their time variation in our experiment. The additional cavity loss rate. [symbol] , and detuning, [symbol] , are a function of plasma loss, αₚ, and refractive index, Δnₚ, which depends on plasma properties (see Methods 2). As evident from Equation 1, increasing plasma absorption, δₚ, increases the transmission through the cavity. Near critical coupling (δ_{c}=δ₀), transmission can rise from 0 to almost 1 as plasma absorption rises (FIG. 11b line 40). In other words, while critically coupled, increasing the absorption of the cavity material reduces cavity absorption and consequently switches on the light emitted through the fibre. This absorption-induced transmission occurs since the higher optical loss is associated with a lower cavity quality factor that takes the fibre-coupled cavity to its under-coupled³³ regime. While under coupled, the effect of the resonator on the nearby fibre waveguide is negligible, so that the fibre turns almost transparent.

Reference is now made to FIGS. 12a to 12d which illustrate an experimental setup according to the present embodiments. In FIG. 12(a) a micrograph of the plasma's glow taken using a visible camera is shown. In FIG. 12(b) a micrograph is shown of the optical resonance taken using a camera sensitive to 1.55 μm wavelength. The 5 spots at the top part of the bubble indicate the transverse cross section of the 5th order transverse mode, as indicated by residual forward scattering (c) Numerical calculation of the 5th order polar mode reveals 4% penetration of the resonating power into the plasma-containing region. (d) Drawing of the experimental system where the red circle represents the optical mode and the orange cones represent electrodes. PD stands for a photodiode

As for changes in refractive index, they cause a drift in the resonance frequency to increase (or reduce) transmission, depending on whether initial detuning conditions are to the red or the blue sides of the resonance wavelength as indicated in FIG. 11e-g, lines 42 and 44 and arrows 46 and 48.

Here, we evanescently couple continuous wave [CW] laser light to the bubble resonator through a tapered fibre coupler³⁴ and monitor transmission by connecting the other side of the fibre coupler to a photodiode. A photodiode for example which is sensitive to visible light may be coupled through free space to monitor plasma luminescence as in the FIG. 12a example. Additionally, we use a visible camera for inspecting plasma luminescence [FIG. 12a] and simultaneously, an infrared [IR] camera inspecting the IR resonance [FIG. 12b] via its residual forward scattering. High-order TM bubble modes are preferred here since they better penetrate the plasma. For example, the 5^{th} order polar mode (FIG. 12b) has 4% of its mode volume overlapping with plasma, as calculated in Methods 2 and shown in FIG. 12c. As for the coupling, the fibre touches the resonator to improve stability. The following experiments measure optical transmission through the cavity at different detuning levels while the plasma is ignited.

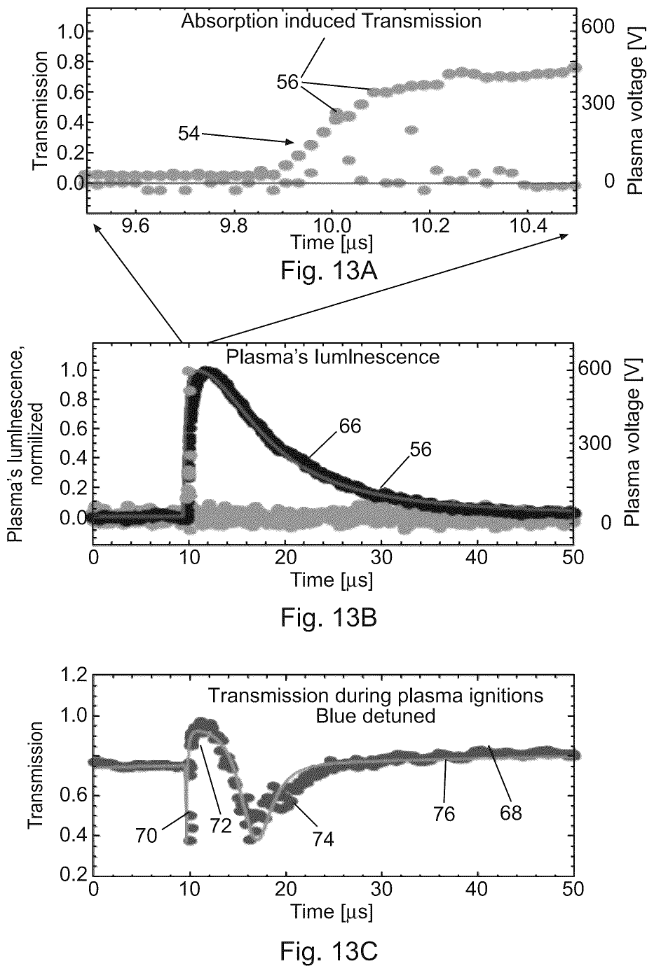

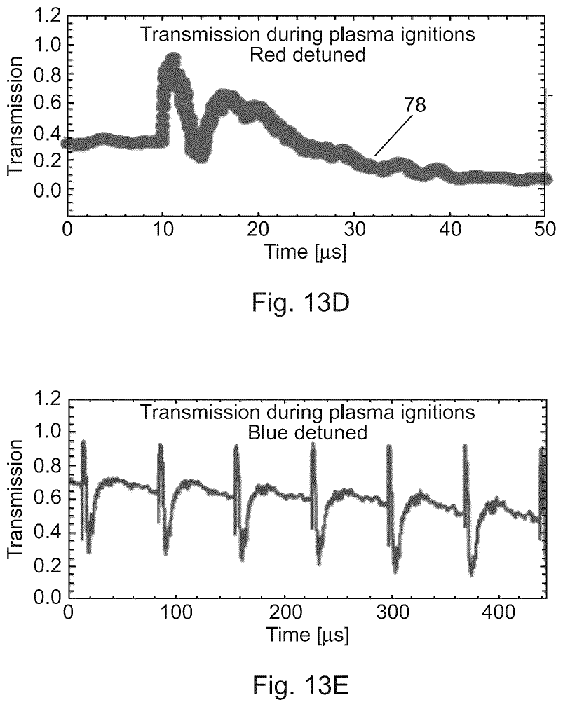

We start by measuring absorption-induced transmission by tuning our laser wavelength to the cavity's optical-resonance wavelength. Plasma pressure is 2.5 Torr. As expected from theory [FIG. 11b-d lines 40, 50, 52], transmission rises from 5% to 78% [FIG. 13a line of green-colored dots 54] upon breakdown and plasma formation. Optical rise-time to half-max power is 100 ns while plasma breakdown is characterized by a voltage rise time of ˜20 ns [FIG. 13a Orange colored dots 56] for electrodes separated by 5 mm. We note that picosecond plasma rise times were possible when the distance between electrodes was closer.

We repeat the transmission measurements, but now while the laser is initially detuned to the red or blue sidebands of the resonance, and not to the resonance centre. We expect that absorption will change transmission regardless of whether detuning is to the blue or red sides of the resonance [FIG. 11d red and blue arrows]. On the contrary, we expect that the changes in the refractive index will result in opposite changes in transmission, depending on the detuning direction [FIG. 12g, blue 60 and red 62 arrows]. When the laser wavelength is at the blue side of the resonance, plasma formation [FIG. 11b] results in a narrow transmission dip followed by a peak and then another dip [FIG. 13c]. As expected from FIG. 11b-g, the dip can be the result of absorption, while the peak that follows can be explained by changes in the refractive index. This qualitative explanation is followed here by fitting our measured transmission [FIG. 12c, dots] to that of equation Eq. 1 [FIG. 12c, line] while taking the plasma's absorption and refraction as free parameters. We achieve the best fit to our experimentally measured transmission with plasma absorption αₚ=3.68 cm⁻¹ and plasma refractive index of 0.999993 for cavity Q of 2×10⁷. This refractive index corresponds to a plasma frequency of ωₚ=4.55×10¹² Rad/s and free-electron density of nₑ˜6×10¹⁵ cm³ (see Methods 2). In order to verify the plasma's electron density we simultaneously measure the optical spectrum of the plasma (see Methods 3) as emitted to a spectrometer through free space (FIG. 11d). The relative intensity of Plasma's 2p6-1s5 and 2p2-Is3 lines gives plasma density nₑ≤1×10¹⁶ cm⁻³ (see Methods 3) in a manner independent of the previous measurements where optical refraction and absorption were used as an input. (b) and (c) were measured simultaneously. The circle size represents the estimated error.

Reference is now made to FIGS. 13a-e. which show experimental results as follows: (a) Absorption-induced transmission: a voltage spike (56 Orange) indicates the electrical breakdown of argon gas to plasma. This breakdown is accompanied by an increase in transmission (54 Green) resulting from plasma's absorption. (b) Plasma luminescence (Black line 64) which we use to estimate the plasma's density. Red line 66 assumes exponential rise and decay. (c) Blue-detuned transmission 68 during plasma ignition shows a dip 70 followed by a peak change 72 governed by absorption followed by a refraction-induced drift 74 that reduces transmission. The blue line 68 shows experimental results. Line 76 is a best fit using Equation 1. (d) Red detuned transmission during plasma ignition-line 78 shows, as expected, absorption-induced effects identical to (c) and refraction-induced effects opposite to (c).

(e) Repeatability and controlled detuning. We can repeat plasma ignition as many times as needed with repeatability as appears in the plot of FIG. 13e. Note that the slight overall downward slope in transmission indicates an intentional slow continuous detuning of the laser frequency in respect with the thermally broadened resonance frequency of the cold cavity. In this manner we can scan to any desired region at the resonance sidebands.

(b) and (c) were measured simultaneously. The circle size represents the estimated error.

In our fitting model, plasma absorption and refraction are assumed to change with plasma density, and plasma density is measured via its luminescence using a photodiode. The plasma density is assumed here to follow the plasma's luminescence but to fall faster due to a faster plasma recombination rate near the solid cavity walls. We perform a control-group experiment by switching to the red side of the resonance where the absorption-dominant region is expected to remain unchanged (FIG. 11d). In contrast, in the refraction-dominant region the transmission structure is expected to invert (FIG. 11g), as we indeed observe (FIG. 13c).

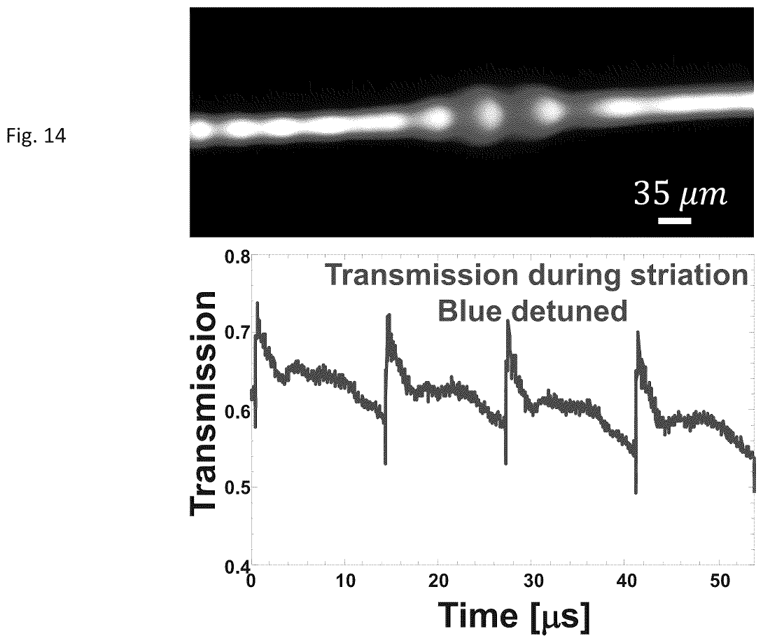

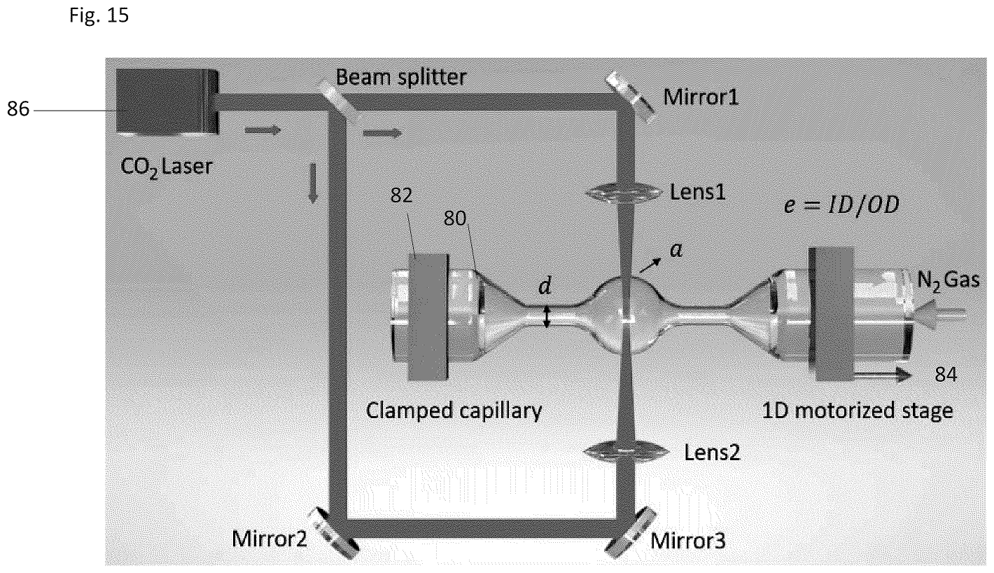

Reference is now made to FIG. 14, which illustrates an embodiment in which we increase the pressure to 5 Torr so that plasma striation appears as the result of interaction between the magnetic field, the electrical current, and charged particles. The smallest striations measured in our system have a 35- [symbol] m wavelength; as known to us, these are among the smallest striations ever observed. Specifically, FIG. 14 shows a plasma standing striation and a micrograph of a plasma ionization wave. The lower parts shows transmission during 4 plasma ignition events while the laser is at the blue detuned side of the resonance. A slight overall slope indicates an intentional continuous detuning of the laser frequency.

In conclusion, we experimentally demonstrate plasma-filled microcavities for the first time. This new type of microcavity paves the way to plasma microphotonics where one can use electric and magnetic properties to control optical refraction, absorption and gain. Our results have broader impact by heralding a new type of plasma-based electro-optical interconnect and high coherence electrically pumped micro-lasers that might be compatible with both on-chip electronics and on-chip vacuum cells. Furthermore, harnessing the ultrahigh Q of cavities to microplasma might improve the resolution of magnetic field sensors.

### Methods

### 1) Microbubble Cavity Fabrication

Reference is now made to FIG. 15, which illustrates microbubble cavities fabricated from commercial fused silica glass microcapillaries (Polymicro Technologies TSP250350) with initial inner and outer diameters of 250 μm and 350 μm respectively. As shown in FIG. 15, a microcapillary 80 was clamped at one end to a stationary mount 82 and the other end to a motorised 1D stage 84 (Thorlabs model, MTS50/M-Z8). A high-power CO₂ laser 86 (Synrad series model, 48-2KWM with 25 W maximum power), was split to make two counter-propagating beams and focussed onto a section of the glass capillary. A moderate power of around 10% (2.5 W) focused onto the capillary generates enough heat to burn off the protective outer metal coating, leaving bare capillary. At 20% of CO₂ laser power, the glass softened reaching around 1700° C.. The power was slowly increased (to compensate for the power to reach the reducing device surface area), while the motorised stage pulled the capillary, tapering it until the outer diameter reached 30-40 μm range. The CO₂ laser was turned off as the stage came to rest. Pressurised gas (N₂ gas at 3 Bar) was introduced into the capillary and the laser was turned on at around 30% power and was very slowly increased until (around 35%) the walls of the capillary became hot and soft enough to allow the pressurised gas to expand it, forming a bubble. While carefully monitoring the laser power, the bubble was allowed to expand further, until the desired diameter, typically in the range of 80-200 μm. The exact dimensions for each bubble were determined after fabrication, using a microscope. Bubble wall thickness can be estimated using the equation, w=a−{square root over (a²−(d²(1−e²)/4))}, where a is the outer diameter of the bubble, d is the tapered capillary outer diameter, e=0.7 is the constant ratio between the inner and outer diameters (ID/OD) of the capillary. The optical Q-factors of the bubbles typically range between 10⁵ and 10⁷ at 1550 nm.

### 2) Theory of Resonantly-Enhanced Light-Plasma Interaction

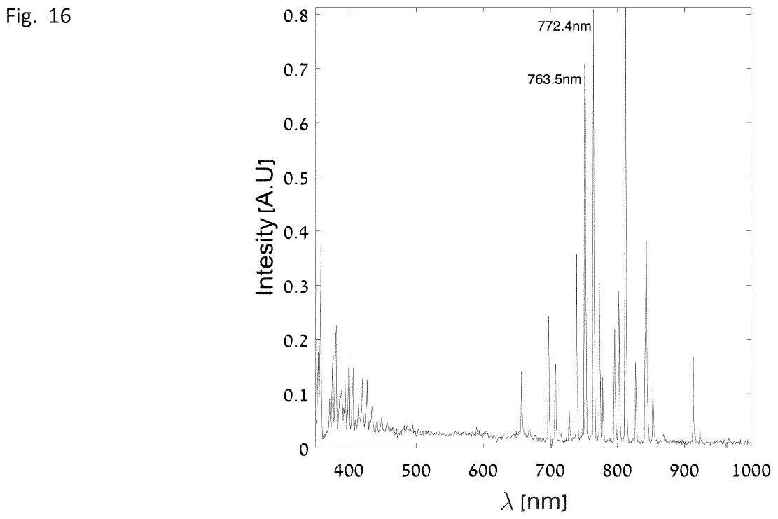

Reference is now made to FIG. 16, which illustrates a plasma emission spectrum as measured via free space.

Using the steady state approximation, the optical transmission through an optical resonator is

| | |
|---|---|
| M1) | $T = 1 - \frac{4 ( {δ}_{c} ) ( {δ}_{0} + )}{{( {δ}_{c} + {δ}_{0} + )}^{2} + {( Δω + )}^{2}} ,$ |

where δ₀ and δ_{c} are cavity coupling and loss rates. Δω is the angular-frequency detuning between the laser and the cold cavity resonance frequency. Plasma results in an additional loss rate, [symbol] , and frequency detuning, [symbol] , where ˜ stands for time variation.

The time varying loss and detuning that plasma induces are

| | |
|---|---|
| M2) | [symbol] = δₚ Dₚ(t)ⁿ, and [symbol] = ΔωₚDₚ(t)ⁿ, |

where Dₚ(t) is plasma density as deduced from plasma luminescence. The plasma density is normalized to have a maximal value of 1 at maximum luminescence. n is a free parameter describing a faster decay of plasma near the bubble wall because of faster recombination of the plasma to a gaseous state of matter. n=3.3 is the best fitting for our experimental results [FIG. 14c].
Plasma's loss rate and frequency detuning at their maximal value are

| | |
|---|---|
| M3) | ${δ}_{p} = \frac{{μ}_{p} {α}_{p} c}{2 n} , {Δω}_{p} = \frac{2 π c {μ}_{p} Δ {n}_{p}}{{λ}_{0} n}$ |

where μₚ=0.04 is the calculated³⁸ fraction of optical power that propagates in the region where plasma resides, c and λ₀ are the vacuum speed and wavelength of light, αₚ is plasma absorption, Δnₚ is plasma refractive index.

The change in refraction and absorption is

| | |
|---|---|
| M4) | ${α}_{p} = \frac{{v}_{e} {ω}_{p}^{2}}{2 c {ω}_{0}^{2}} , Δ {n}_{p} = \sqrt{1 - \frac{{ω}_{p}^{2}}{{ω}_{0}^{2}}} - 1 ≅ - \frac{{ω}_{p}^{2}}{2 {ω}_{0}^{2}}$ |

where νₑ is plasma recombination rate and ω₀ is the angular optical frequency and ωₚ is plasma frequency.

| | |
|---|---|
| M5) | ${ω}_{p}^{2} = \frac{{e}^{2} {n}_{e}}{{ε}_{0} {m}_{e}}$ |

where e and mₑ are the charge and mass of the electron, nₑ is free-electron density, and ε₀ is vacuum permeability.

### 3) Plasma Emission Spectrum

To confirm plasma electron density as measured via the optical refraction and absorption, we conduct a simultaneous independent measurement that is based on spectral line analysis. We measure argon spectral lines [symbol] ₁=763.5 [nm]:2p6-1s5 and [symbol] ₂=772.4 [nm]:2p2-1s3 (FIG. 17.) and calculate their relative power. We assume corona steady-state equilibrium; that is, ion excitation occurs due to electron collisions. Also we expect de-excitation by spontaneous emission, which means that the plasma is optically thin and photons mostly escape without interacting with neutrals and ions. For electron temperature Te˜1 [eV] we get plasma electron density is nₑ≤1×10¹⁶ cm.

In the present disclosure, the terms “comprises”, “comprising”, “includes”, “including”, “having” and their conjugates mean “including but not limited to”.

The term “consisting of” means “including and limited to”.

As used herein, the singular form “a”, “an” and “the” include plural references unless the context clearly dictates otherwise.

It is appreciated that certain features of the invention, which are, for clarity, described in the context of separate embodiments, may also be provided in combination in a single embodiment and the present description is to be construed as if such embodiments are explicitly set forth herein. Conversely, various features of the invention, which are, for brevity, described in the context of a single embodiment, may also be provided separately or in any suitable subcombination or may be suitable as a modification for any other described embodiment of the invention and the present description is to be construed as if such separate embodiments, subcombinations and modified embodiments are explicitly set forth herein. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

What is claimed is:

1. An optical cavity resonator, comprising a transparent or nearly transparent dielectric, and having gas or plasma provided thereabout, the resonator constructed to have an optical resonance that extends to partially spatially overlap with said gas or plasma, the gas or plasma providing an optical gain at a frequency overlapping a resonant frequency of said resonator, wherein the optical cavity is constructed with plasma, and able to be pumped such that the plasma is able to amplify light at a frequency approximately related to an atomic transition frequency of said gas or plasma.

2. The optical cavity resonator of claim 1, wherein said gas or plasma comprises one member of the group consisting of Nitrogen, CO2, Argon ions, Helium-Neon mixture, ammonia, and a Xenon-Neon Mixture.

3. The optical cavity resonator of claim 1, configured to bring said gas or plasma to an optical population inversion state using one member of the group consisting of electric discharge, molecular collisions, flow, heat, chemical reaction, and optical pumping with another source of light.

4. The optical cavity resonator of claim 1, being a micro-cavity resonator.

5. The optical cavity resonator of claim 1, configured with optical resonances that partially overlap with regions outside or inside the resonator, to which regions said gas or plasma is introduced.

6. The optical cavity resonator of claim 1, configured with optical resonances that partially overlap with regions outside and inside the resonator, to which regions said gas or plasma is introduced, such that said gas or said plasma is both inside and surrounding said optical cavity resonator, the resonator thereby propagating an optical mode partially at a solid part of the microcavity and partially at said regions to which said gas or plasma is introduced.

7. The optical cavity resonator of claim 1, configured to bring more than half of the gas or plasma atoms to an excitation energy level.

8. The optical cavity resonator of claim 1, configured to amplify spontaneous emission occurring at a population inversion region, and/or to amplify a weak seed light source, and/or to amplify light originating from noise, and/or to amplify light from thermal background radiation.

9. The optical cavity resonator of claim 8, wherein said amplifying is carried out by said gas or plasma, and wherein feedback inherent to resonators may populate one or more of the cavity modes at a predetermined power.

10. The optical cavity resonator of claim 9, wherein said predetermined power is between 1 nano Watt and 1 Watt.

11. The optical cavity resonator of claim 9, configured such that photons from said amplifying circulate while partially in contact with the population-inversion region.

12. The optical cavity resonator of claim 1, having an inside and an outside and wherein laser light from resonance inside said micro-cavity is coupled to the outside of the resonator.

13. The optical cavity resonator of claim 1, wherein said coupling laser light out of the resonator comprises one member of the group consisting of scattering said light from a rough surface, using a brag grating, using radiation at a sharp curve, using a nearby tapered fiber, using a nearby waveguide, using a bent waveguide, and using a prism.

14. The optical cavity resonator of claim 1, wherein said transparent or nearly transparent dielectric comprises a hollow shell or a disc.

15. The optical cavity resonator of claim 1, incorporated into one member of the group consisting of an optical gyroscope, an optical gyroscope used for internal navigation, a ring laser gyroscope (RLG), a ring cavity gyroscope, a local oscillator, a local oscillator operating at the 7 to 30 GHz band and based on beating two resonator optical modes, with related frequency separation, on a photodiode, a narrow-linewidth laser emitter, and a micro frequency comb.

16. A method of providing laser light, comprising providing a gas or plasma at an optical population inversion around a transparent or nearly transparent dielectric, the dielectric providing a resonant cavity therewithin, the cavity having an optical resonance that extends to partially spatially overlap with said gas or plasma, the gas or plasma thereby providing an optical gain at a frequency overlapping a resonant frequency of said resonant cavity, and
pumping plasma, thereby causing the plasma to amplify light at a frequency approximately related to a relevant atomic transition frequency of said gas or plasma.

17. The method of claim 16, comprising amplifying spontaneous emission occurring at a population inversion region, and/or amplifying a weak seed light source, and/or amplifying light originating from noise, and/or amplifying light from thermal background radiation.

18. The method of claim 16, comprising coupling laser light from resonance inside said cavity to an outside of said resonator.

19. The method of claim 18, wherein said coupling said laser light out of the resonator comprises one member of the group consisting of scattering said light from a rough surface, using a brag grating, using radiation at a sharp curve, using a nearby tapered fiber, using a nearby waveguide, using a bent waveguide, and using a prism.

20. A method of providing laser light, comprising:
fabricating a microbubble cavity from a fused silica glass microcapillary;
providing a gas or plasma at an optical population inversion around a transparent or nearly transparent dielectric within said cavity, the cavity having an optical resonance that extends to partially spatially overlap with said gas or plasma, the gas or plasma thereby providing an optical gain at a frequency overlapping a resonant frequency of said resonant cavity, and
pumping plasma, thereby causing the plasma to amplify light at a frequency approximately related to a relevant atomic transition frequency of said gas or plasma.
